(19) United States
(12) Patent Application Publication
(10) Pub. No.: US 2024/0181521 A1
(43) Pub. Date: Jun. 6, 2024

(54) METHOD OF MAKING METAL FIBERS, IN PARTICULAR OF STEEL

(71) Applicant: HACANOKA GMBH, Vöhringen (DE)

(72) Inventor: Karl-Hermann STAHL, Voehringen (DE)

(21) Appl. No.: 18/284,445

(22) PCT Filed: Apr. 12, 2022
(86) PCT No.: PCT/EP2022/059742

§ 371 Date: Oct. 12, 2023

(30) Foreign Application Priority Data
Dec. 4, 2021 (DE) 102021001946.6

(51) Int. Cl. B21F 13/00; B21B 1/16; B21C 37/04

(52) U.S. Cl. CPC B21F 13/00; B21B 1/16; B21C 37/045

(57) ABSTRACT

The method is used to make metal fibers, more particularly steel fibers, from strip-shaped flat material, where the metal fibers have a substantially rectangular cross-section, and at least one of the wide side faces, preferably both of the wide side faces, is provided with at least one V-shaped anchor groove running longitudinally of the fiber. First, a material matched to the strength required for the metal fibers when they are used later on is used as the metal strip. In a first production line the metal strip, is fed from a coil to a straightening and transporting unit (3) by a driven and controlled unwinder (1). Downstream of a crop shear (4) that forms the leading end of the strip, the metal strip is fed to a profiling roll pair (6) consisting of an upper roll and a lower roll and forming a rolling tool. The profiling roll pair introduces anchor grooves and fracture grooves. Subsequently, the metal strip passes through a combined scoring and straightener (7) for scoring or straightening the anchor lines in the fracture grooves by means of one or more scoring roller pairs, and the metal strip is finally wound as a coil again by a winder (8). Thereafter, the last process step of the fiber make is carried out at a longitudinal and transverse dividing unit.

The invention relates to a method of making metal fibers, in particular tempered or untempered steel fibers, from strip-shaped flat material. The metal fibers have a substantially rectangular cross-section and at least one of the wide side faces, preferably both of the wide side faces, is provided with at least one V-shaped anchor groove extending longitudinally of the fiber, and, in order to form the metal fibers, a metal strip is preferably formed with fracture grooves on both metal strip surfaces in the longitudinal direction, as a result of which separation webs are formed at the groove bases. Optionally downstream of a rolling process, the separation webs are split by bending to form burr-free and fracture-free edge faces.

The invention also relates to an apparatus for carrying out this method and to a metal, in particular steel, fiber made according to the method.

Metal fibers of this type have already been described, in particular in DE 10 2017 006 298 [U.S. Pat. No. 10,995,493]. Such metal fibers serve as admixture in concrete with the aim of compensating for cracks occurring in concrete components and causing a reduction of the tensile load, that is to say, in turn to absorb the tensile load, and to in effect stitch up the crack, figuratively speaking. In order to achieve this, the greatest possible number of metal fibers must be distributed as uniformly as possible in the component. For this purpose, the metal fiber should be thin, so that a high number of parts per weight unit, and thereby statistically a high homogeneity, is achieved. It is important here that the metal fibers should have no or no large projections sticking out from their surfaces, such as hooks at the fiber ends and the like, which could cause “clumping” of the metal fibers in the concrete, and thus “hedgehog formation” that would lead to uneven distribution. On the other hand, for the effect of the metal fiber under tensile load to be achieved, the anchorages together with the strength of the material used are specifically decisive for the tensile load capacity.

In order to meet the performance specifications required in the construction industry, coordination is required with regard to the design of the metal fiber, on the one hand, and the fiber material to be used in terms of strength and strain on the other hand. In the context of the object of the invention, it is also particularly important to be able to use the simplest possible, most cost-effective making technology possible.

According to the invention, this object is attained from a process point of view in that a material is first used as the metal strip conforming to the strength required for the metal fiber in subsequent use, the metal strip being supplied in a first production line from a coil by a driven and controlled unwinder (1) to a straightening conveyor (3) provided with an overrunning clutch enabling freewheeling and to a downstream crop shear (4) that forms at least the leading end of the strip. Then, the metal strip is fed to a profiling roll pair (6) consisting of an upper roll and a lower roll together forming a rolling tool for forming both anchor grooves that are axially offset from one another on the upper and lower side faces, and fracture grooves. the two rolls may be provided with interruptions for forming anchor faces and/or anchor lines in the anchor grooves or the fracture grooves, that form respective anchor lines on the metal strip, to which end the rolls can be precisely synchronized properties for exact positioning of the anchor lines with respect to the upper and lower rolls and are additionally equipped with stable and adjustable axial guidance of the two rolls with respect to one another. Finally the metal strip then passes, if required, through a combined scoring and straightener (7) for deeper grooving, scoring or straightening of the anchor lines in the fracture grooves with one or more scoring roller pairs, and is finally wound up again as a coil by a winder (8) or is conveyed further in the corresponding production line.

The progress achieved by the invention consists, among other things, in that an adapted material can be provided for the forming process of the metal fibers, i.e. in particular the profile rolling, as a result of which smaller rolls can be used due to the lower bending forming force for the anchor grooves and thus a lower rolling force. The metal strip can be selected to be relatively thin, so that the webs of the fracture grooves between the metal fiber strands can be designed to be very small and thus simplify subsequent separation. The provision of the anchor grooves on the upper and lower faces of the metal strip, in which the inner anchor lines are provided, makes it possible to keep the axial forces within more easily controllable limits due to their mutual offset by a guide function that significantly reduces the mechanical effort. Finally, the manufacturing process of grooving, tempering, and separating described above allows for a very space-saving storage of the metal fiber strips, since the separation into metal fibers can be carried out as needed at a later point in time, since metal fibers loaded into a container, such as a big bag, take up significantly more space and their subsequent separation for admixture in concrete is complex and usually requires specially equipped devices for this purpose.

Within the scope of the invention, it is also possible, in particular, for the metal strip to optionally pass through a plurality of rolling stations in the optional scoring unit and straightener downstream of the scoring roller pairs, downstream of which an optical scanning of the anchor lines present in the anchor grooves and anchor lines perpendicular to the direction of travel of the metal strip takes place, and herewith control of a longitudinal subdividing shear takes place that, if necessary, carries out a preseparation of the metal fiber strands along the anchor lines in the region of the fracture groove, whereupon a longitudinal subdividing roll separates the preseparated fibers from the metal strip substantially in the anchor region, and the profiled metal strip is drawn through the separating roll by a downstream traction-roll pair, but the latter also requires an auxiliary, controlled drive of its own, and, upstream of the winder, a straightener having a crop shear and a further straightener for prebending the profiled metal strip are optionally provided before coiling. Instead of coiling, however, the fibers can also be made immediately, especially if no tempering is planned. Due to the relatively thin separation webs, even downstream of a carried out tempering process of the metal strip, a particularly simple and low-interference slitting is possible by means of a braked separating roll that may optionally be provided with an auxiliary drive.

Following these process steps, depending on the starting material used or the properties of the desired end product, the profiled metal strip can then be subjected to a common and usual heat treatment process that will therefore not be described in detail here.

Furthermore, the invention provides that in an alternative second production line, downstream of the optional scoring unit and the preseparation, the profiled and, if necessary, tempered metal strip is unwound from a driven and controlled unwinder and fed into a straightener in turn equipped with an overrunning clutch, for straightening and drawing in the leading end of the strip, which itself may be provided with a clean, flat end face by a downstream crop shear, whereupon, after passing through a flat, narrow strip guide, an optical scanning of the anchor lines present in the anchor grooves and anchor lines perpendicular to the direction of travel of the metal strip takes place, which serves the subsequent control of a transverse cutting shear, and, after passing through a further flat, narrow strip guide, the complete separation of the metal fibers from one another takes place in braked longitudinal subdividing rolls or longitudinal subdividing rolls provided with an auxiliary drive, for which purpose the separated metal fibers are drawn through a narrow guide with a high tensile load applied by a traction-roll pair, and, still longitudinally separated, are pushed closely guided into a transverse dividing shear and finally cut to length and fed into a collecting container for the separated metal fibers.

For carrying out the above-described process in terms of an apparatus in which metal fibers, in particular steel fibers, are made from strip-shaped flat material, having a substantially rectangular cross-section and at least one, preferably both, of its wide side faces provided with at least one V-shaped anchor groove extending in the longitudinal direction of the fibers and, for forming the metal fibers, the metal strip is formed with fracture grooves, preferably on both metal strip faces forming separation webs at the groove base thereof that form low-burr and fracture-rough edge faces during subsequent separation, optionally also after a rolling process deforming the separation webs by bending. The invention proposes that a driven and controlled unwinder for the metal strip in the form of a coil is provided in the first production line, furthermore a straightening conveyor for the metal strip itself provided with an overrunning clutch enabling a freewheel, furthermore a downstream crop shear for forming at least the leading end of the strip, furthermore a profiling roll pair consisting of an upper roller and a lower roller and designed as a rolling unit for forming the anchor grooves and the fracture grooves into the metal strip, the synchronization properties of the two rollers and their axial guidance relative to one another being precisely adjustable, further optionally with a combined scoring and straightener with one or more pairs of scoring rollers for grooving, scoring or also, if desired, for straightening the anchor lines in the fracture grooves in the metal strip, and finally with a winder for rewinding the metal strip into a coil.

In this case, it is advantageous and therefore preferred within the scope of the invention that a plurality of rolling stations for the metal strip are provided downstream of the scoring roller pairs, if necessary, that further an optical scanning unit is provided for the anchor lines present in the anchor grooves and anchor lines perpendicular to the direction of travel of the metal strip, for control of a longitudinal subdividing roll that preseparates the metal fiber strands at the anchor lines in the region of the fracture groove. A downstream traction-roll pair is provided for advancing the profiled metal strip, and, upstream of the winder, a straightener having a crop shear for prebending the profiled metal strip is optionally arranged prior to the coiling, wherein, instead of coiling, the units required for longitudinal and transverse dividing can also be provided in accordance with a second production line.

For the second production line, it is advantageous if, for unwinding the now profiled and/or optionally tempered metal strip, a driven and controlled unwinder is again provided, as well as a straightener, again equipped with an overrunning clutch, for straightening and drawing in the leading end of the strip, furthermore a crop shear for applying a clean, flat end face to the leading end of the strip, furthermore an optical scanning device for determining the anchor lines present in the anchor and fracture grooves and forming anchor lines perpendicular to the direction of travel of the metal strip, where for guiding the metal strip in front of and downstream of the optical scanning device, flat, narrow strip guides are provided for the metal fibers that are partially separated from one another, in that furthermore braked or optionally drive-supported longitudinal subdividing rolls are provided for complete separation of the metal fiber strands from one another, as well as a traction-roll pair, wherein for the longitudinally separated metal fiber strands a narrow guide is provided leading to the transverse dividing shears that are controlled by the optical scanning device and cut the metal fiber strands to length. The fibers are fed into a collecting container.

In this case, it has proven to be advantageous if the scoring and straightener is provided with a plurality of, preferably two, scoring roller pairs.

Finally, the invention relates to a metal fiber, in particular a steel fiber formed from strip-shaped flat material, the metal fiber having a substantially rectangular cross-section and at least one, preferably both, of the respective wide side faces being provided with at least one V-shaped anchor groove extending in the longitudinal direction of the fiber. The metal fiber is formed from a metal strip provided in the longitudinal direction, preferably on both metal strip surfaces, with fracture grooves whose bases form separation webs that, on subsequent separation, optionally also after a rolling process deforming the separation webs by bending, form low-burr and fracture-rough edge faces, and the metal strip used consists of a material adapted with respect to the strength required for the metal fiber in subsequent use, wherein furthermore the axially spaced anchor grooves formed on the upper and lower side faces as well as the fracture grooves are introduced by a profiling roll pair consisting of an upper roll and a lower roll and in the form of a rolling tool whose two rolls have exactly synchronous running properties and that can be provided with undercuts for the formation of anchor surfaces and/or anchor lines in the anchor grooves and the fracture grooves, respectively, whereby the fracture grooves can be grooved or scored more deeply by the scoring roller pairs of a scoring and straightener, or the anchor lines in the fracture grooves may be leveled.

The invention is explained in more detail below with reference to an embodiment in the form of an apparatus, therein:

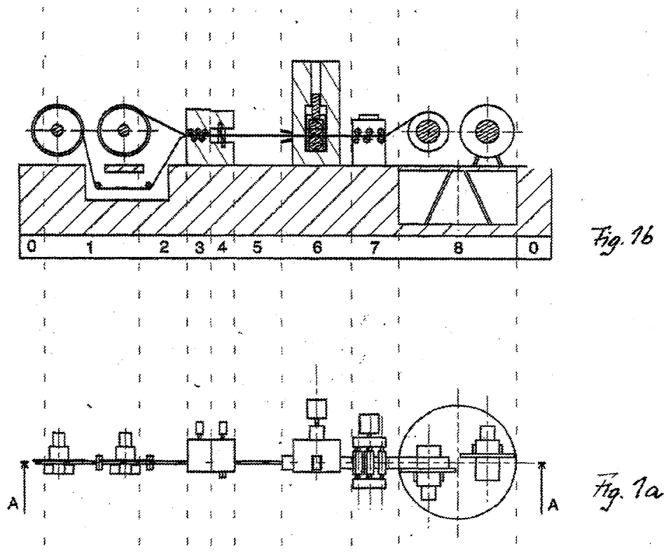

FIG. 1 is a schematic view of a production line according to the invention from cold strip to the profiled metal strip in a first embodiment,

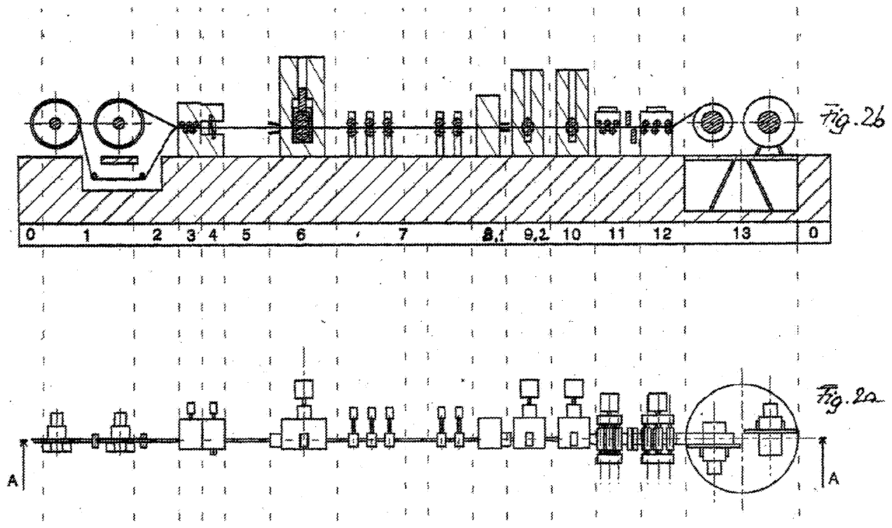

FIG. 2 is a view corresponding to FIG. 1 of an alternative embodiment in plan view a) and section b), all of the structural units also provided being shown only optionally,

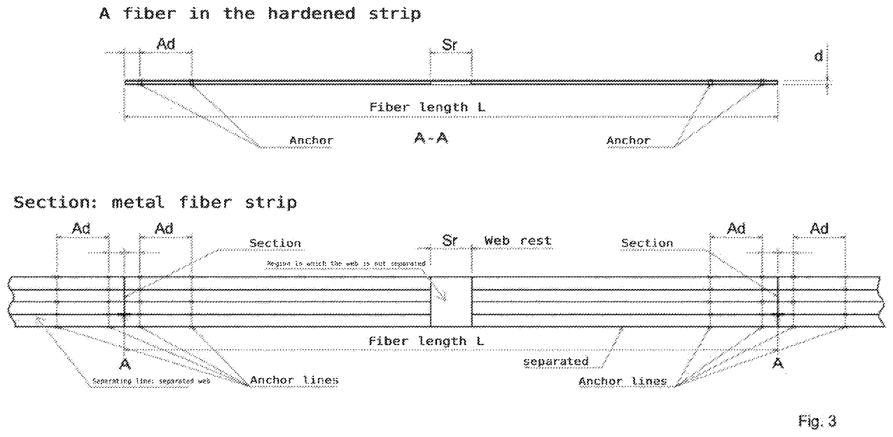

FIG. 3 is a detail of the grooved metal strip with the anchor lines and the unsevered web (web scrap),

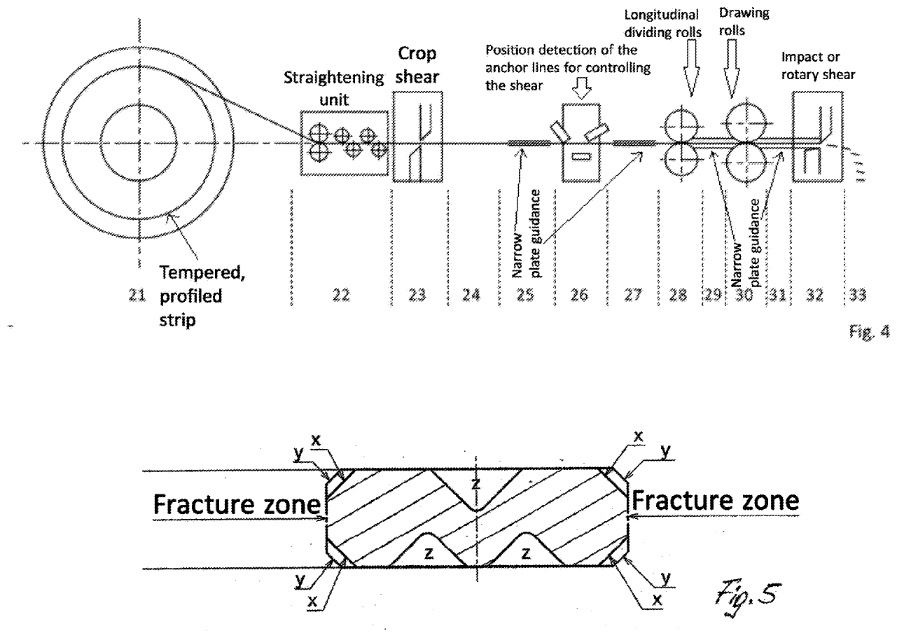

FIG. 4 is the production line adjoining according to FIG. 1 or 2 showing from profiled metal strip to profiled metal fiber in a side view,

FIG. 5 is a metal fiber in section.

The arrangement shown in the drawing is provided for carrying out a method of making metal fibers, in particular steel fibers, from a strip workpiece. These metal fibers, shown by way of example in FIG. 5 in section, have a substantially rectangular cross-section, and at least one, but preferably both of the respectively wide fiber side faces are provided with at least one V-shaped anchor groove extending in the longitudinal direction of the fiber. In order to create the metal fibers, the metal strip is provided with longitudinally spaced fracture grooves, preferably on both metal strip surfaces, such that separation webs are formed at their groove bases. These separation webs, during subsequent separation, optionally only after a rolling process deforming the separation webs by bending, form low-burr and fracture-rough edge faces.

The metal strip used here is usually a material initially conforming to the strength required for the metal fiber in its subsequent use. According to FIG. 1, the metal strip is supplied in a first production line at 1 from a coil by a driven and controlled unwinder to a straightening conveyor 3 provided with an overrunning clutch enabling freewheeling. It also has a downstream crop shear 4 forming at least the leading end of the strip.

The metal strip is then fed to a profiling roll pair 6 consisting of an upper roll and a lower roll and formed as a rolling unit used to create both the anchor grooves axially succeeding from one another on the upper and lower side faces and the fracture grooves that form the anchor lines. The profiling roll pair 6 has precisely adjustable synchronization of both rolls to achieve exact positioning of the anchor lines on the upper roll to the lower roll. Furthermore, it is equipped with a likewise stable and adjustable axial guidance of the two rolls with respect to one another. Subsequently, if required, the metal strip passes through a combined scoring and straightener 7 for scoring the anchor lines in the fracture grooves with one or more scoring roller pairs, two scoring roller pairs having preferably proved effective. Finally, the metal strip is rewound as a coil by a winder 8. When installing the individual components just described, care must be taken to ensure that there is sufficient clearance 2 and 5 downstream of both the unwinder 1 and the crop shear 4 for winding and threading on the coil leading end and for preparing the ring leading end.

In an alternative process sequence according to FIG. 2, in which the same reference signs are used for positions 1 to 7, the metal strip optionally passes through several rolling stations in the scoring and straightener 7 downstream of the scoring roller pairs, an optical detection 9.1 taking place of the anchor lines present in the grooves and arranged in anchor lines transverse to the direction of travel of the metal strip. This makes it possible to control a longitudinal subdividing roll 9.2 that performs a preseparation of the metal fiber strands in the anchor area of the fracture grooves, with the profiled metal strip being pulled through the longitudinal subdividing roll by a downstream traction-roll pair 10. As a result, the longitudinal subdividing roll requires no or only an auxiliary drive of its own. Upstream of the winder 13, a straightener 11 having a crop shear and a further straightener 12 for prebending the profiled metal strip prior to coiling can optionally be provided. For metal fibers without tempering, the machine units at 11-13 are to be replaced with the machine units 25-33 according to FIG. 4.

FIG. 3 is a side view and a plan view of the metal fiber strip where the regions in which the webs are separated or respectively not separated are visible. The anchor lines are also visible, as is the subdivision line A on which the fibers are cut to length.

The profiled metal strip can then optionally be subjected to a common and usual tempering process in a subsequent method step in a manner not shown in detail.

In a second production line, shown schematically in FIG. 4, the profiled and tempered metal strip is unwound by a driven and controlled unwinder 21 and fed into a straightener 22, again equipped with an overrunning clutch, for straightening and drawing in the leading end of the strip. In this case, the leading end of the strip is provided with a clean, flat end face by a downstream crop shear 23. Here again, provision must be made for sufficient clearance 24 downstream of the crop shear 23 for processing or threading the leading end of the strip.

After passing through a flat, narrow strip guide 25, an optical scanning of the anchor lines present in the anchor grooves and perpendicular to the direction of travel of the metal strip takes place at 26, which serves the subsequent control of a transverse dividing shear. After passing through another flat, narrow strip guide 27, the complete separation of the metal fibers from one another takes place in braked longitudinal subdividing rolls 28 or longitudinal subdividing rolls 28 provided with auxiliary drive, for which purpose the separated metal fibers are fed through a narrow guide 29 with a high tensile load to a traction-roll pair 30.

After continued narrow plate guidance 31, the longitudinally divided metal fiber strands are pushed into a transverse dividing shear 32 and cut to length, and finally fed into a collecting container 33 for the separated metal fibers.

1. A method of making metal fibers,
tempered or untempered steel fibers from strip, where the steel fibers each have a substantially rectangular cross-section and at least one wide side face provided with at least one V-shaped anchor groove extending longitudinally of the fiber, and, to form the steel fibers, the steel strip is provided on at least one of the steel strip surfaces with longitudinal fracture grooves, as a result of which separation webs are formed at the groove bases and themselves form low-burr and fracture-rough edge faces during subsequent separation, wherein a material conforming to the strength required for the steel fiber in subsequent use is initially used as the steel strip, the steel strip being supplied in a first production line from a coil by a driven and controlled unwinder to a straightening conveyor provided with an overrunning clutch enabling freewheeling, and to a downstream crop shear forming at least the leading end of the strip, whereupon the metal steel strip is fed to a profiling roll pair consisting of an upper roll and a lower roll forming a rolling tool for creating both the anchor grooves that are axially offset from one another on the upper and lower side faces, as well as the fracture grooves, the two rolls being provided with undercuts for forming anchor surfaces and/or anchor lines in the anchor grooves and the fracture grooves that form respective anchor lines on the steel strip, for which purpose the rolls can be precisely synchronized for exact positioning of the anchor lines with respect to the upper and lower rolls and are additionally equipped with stable and adjustable axial guidance of the two rolls with respect to one another, the steel strip then passing, if required, through a combined scoring device and straightener for deeper grooving, scoring or straightening of the anchor lines in the fracture grooves with one or more scoring roller pairs and being finally wound up again as a coil by a winder or continues in a corresponding production line.

2. The method according to claim 1, wherein downstream of the scoring roller pairs an optical scanning takes place of the anchor lines present in the grooves and arranged on anchor lines perpendicular to the direction of travel of the steel strip, and therewith monitoring is done of a longitudinal subdividing roll that carries out a preseparation of the steel fiber strands in the anchor region of the fracture grooves, and the profiled steel strip is drawn through the longitudinal subdividing roll by a downstream traction-roll pair such that the longitudinal subdividing roll requires no drive or only an auxiliary drive of its own, a straightener having a crop shear and a further straightener for prebending the profiled steel strip prior to coiling being optionally provided upstream of the winder.

3. The method according to claim 1, wherein the profiled steel strip is subjected to a common and usual tempering process in a subsequent process step.

4. The method according to claim 1, wherein in a second production line a coil of the profiled and/or tempered steel strip is unwound by a driven and controlled unwinder and fed to a straightener, again equipped with an overrunning clutch, for straightening and drawing in the leading end of the strip, the leading end of the strip being provided with a clean, flat end face by a downstream crop shear, whereupon, after passing through a flat, narrow strip guide, an optical scanning is effected of the anchor lines present in the anchor grooves and perpendicular to the direction of travel of the steel strip, which serves for the subsequent control of a transverse dividing shear, and after passing through a further flat, narrow strip guide, the complete separation of the steel fibers from one another takes place in braked longitudinal subdividing rolls or longitudinal subdividing rolls provided with an auxiliary drive, for which purpose the separated steel fibers are drawn through a narrow guide with a high tensile load by a traction-roll pair and further narrowly guided into a transverse dividing shear and cut to length and finally fed to a collecting container for the separated steel fibers.

5. An apparatus for carrying out the method according to claim 1, wherein steel fibers are made from strip-shaped flat material, the steel fibers having a substantially rectangular cross-section and at least one of the wide side faces being provided with at least one respective V-shaped anchor groove extending in the longitudinal direction of the fibers and, to form the steel fibers, the steel strip is formed with fracture grooves on at least one of the steel strip faces, and separation webs are formed at the groove base thereof to form low-burr and fracture-rough edge faces during subsequent separation, optionally also after a rolling process that deforms the separation webs by bending, wherein a driven and controlled unwinder for a coil of the steel strip is provided in a first production line, further a straightening conveyor for the steel strip provided with an overrunning clutch enabling freewheeling, further a downstream crop shear for forming at least the leading end of the strip, further a profiling roll pair consisting of an upper roll and a lower roll and forming a rolling tool unit, for forming the anchor grooves and the breaking grooves in the steel strip, synchronization of the two rolls and their axial guidance relative to one another being precisely adjustable, further comprising a combined scoring unit and straightener having one or more scoring roller pairs for deeper grooving, scoring, or also, if desired, for straightening the anchor lines in the fracture grooves in the steel strip, and finally comprising a winder for rewinding the steel strip as a coil.

6. The apparatus according to claim 5, wherein, if required, a plurality of rolling stations for the steel strip are provided downstream of the scoring roller pairs, an optical scanning unit being provided for the anchor lines present in the anchor grooves and arranged on anchor lines perpendicular to the direction of travel of the steel strip for controlling a longitudinal subdividing roll that enables a preseparation of the steel fiber strands of the anchor lines in the region of the fracture grooves, and a downstream traction-roll pair is provided for driving the profiled steel strip, and a straightener having a crop shear for the prebending of the profiled steel strip prior to the coiling is optionally provided upstream of the winder.

7. The apparatus according to claim 5 for carrying out a second production line, characterized in that wherein for unwinding the now profiled and tempered steel strip, there is again provided a driven and controlled unwinder and a straightening device, again equipped with an overrunning clutch, for straightening and drawing in the leading end of the strip, further a crop shear for forming a clean, flat end face to the leading end of the strip, further an optical scanning device for detecting the anchor lines present in the anchor and fracture grooves and arranged on anchor lines perpendicular to the direction of travel of the steel strip, wherein, for guiding the steel strip in front of and downstream of the optical scanning device, flat, narrow strip guides are provided for the steel fibers that have been partially separated from one another, braked longitudinal subdividing rolls being provided for completely separating the steel fiber strands from one another, as well as a traction-roll pair, wherein the steel fiber strands are pushed by the traction-roll pair through a narrow guide of a transverse dividing shear controlled by the optical position detection device for cutting to length, and the fibers are fed into a collecting container.

8. The apparatus according to claim 5, wherein the scoring and straightener is provided with a plurality of scoring roller pairs.

9. A steel fiber, according to claim 1, formed from strip-shaped flat material, wherein the steel fiber has a substantially rectangular cross-section and at least one of the respective wide side faces is/are provided with at least one V-shaped anchor groove extending in the longitudinal direction of the fiber, the steel fiber being formed from a steel strip provided on at least one of the steel strip faces, with fracture grooves, the groove bases of which form separation webs that, during subsequent separation, wherein the steel strip used consists of a material adapted with respect to the strength required for the steel fiber in subsequent use, wherein the anchor grooves arranged axially offset from one another on the upper and lower side faces as well as the fracture grooves are introduced by a profiling roll pair consisting of an upper roll and a lower roll and forming a rolling tool, the two rollers of which, which have exactly synchronous running properties, can be provided with undercuts for forming anchor surfaces and/or anchor lines in the anchor grooves or the fracture grooves, wherein the fracture grooves may be grooved deeper, scored deeper or the anchor lines in the fracture grooves may be leveled by the scoring roller pairs of a scoring and straightener.
